(19) United States
(12) Patent Application Publication
(10) Pub. No.: US 2025/0227213 A1
(43) Pub. Date: Jul. 10, 2025

(54) STORING IMAGE DATA IN AN IMAGE RECORDING SYSTEM

(71) Applicant: Sphere Entertainment Group, LLC, New York, NY (US)

(72) Inventors: Deanan DASILVA, Malibu, CA (US); Michael Graae, Brooklyn, NY (US); Jason Daughenbaugh, Bozeman, MT (US); Anthony James Lukes, Bozeman, MT (US)

(73) Assignee: Sphere Entertainment Group, LLC, New York, NY (US)

(21) Appl. No.: 19/014,880

(22) Filed: Jan. 9, 2025

Related U.S. Application Data
(60) Provisional application No. 63/619,555, filed on Jan. 10, 2024.

(51) Int. Cl. H04N 9/79; H04N 5/77

(52) U.S. Cl. CPC H04N 9/79; H04N 5/77

(57) ABSTRACT

Systems, methods, and apparatuses can store digital image data that is related to an image, or a series of images, commonly visualized as video. These systems, methods, and apparatuses can store the digital image data as unprocessed digital image data in a raw image format that includes color information, for example, luminance and/or chrominance color components of YUV color model and/or red, green, and/or blue color components of a red, green, blue (RGB) color model to provide some examples, for each pixel of the image. These systems, methods, and apparatuses can stripe the digital image data into multiple blocks of image data and can, thereafter, partitions the multiple blocks of image data into multiple blocks of pixel data. These systems, methods, and apparatuses can distribute the multiple blocks of pixel data across multiple memory modules that can operate in parallel to improve read and/or write performance.

### CROSS-REFERENCE TO RELATED APPLICATIONS

The present application claims the benefit of U.S. Provisional Patent Application No. 63/619,555, filed Jan. 10, 2024, which is incorporated herein by reference in its entirety.

### BACKGROUND

Most modern digital cameras acquire images using a single image sensor overlaid with a color mask, such as a Bayer filter mosaic to provide an example, that absorbs undesired color wavelengths so that each pixel of the single image sensor is sensitive to a specific color wavelength. The color mask is a mosaic of tiny color filters placed over the pixel sensors of the single image sensor to capture color information, such as red, green, and/or blue color components of a red, green, blue (RGB) color model to provide some examples. Often times, the modern digital cameras read the digital image data row-wise, namely, along a series of rows, from the single image sensor in a raw image format. However, modern digital cameras reconstruct and save a full-color image from the digital image data in the raw image format. Unlike the digital image data in the raw image format, the full-color image is capable of being displayed. Often times, this reconstruction necessarily results in the loss of information stored in the raw image format. For example, the image quality of the JPEG file format is less than the image quality of the raw image format as the JPEG file format only accommodates 256 shades of color as compared to between 4,096 and 65,535 shades of color of the raw image format.

### BRIEF DESCRIPTION OF THE DRAWINGS

The present disclosure is described with reference to the accompanying drawings. In the drawings, like reference numbers indicate identical or functionally similar elements.

Additionally, the left most digit(s) of a reference number identifies the drawing in which the reference number first appears. In the accompanying drawings:

FIG. 1 illustrates a simplified block diagram of an exemplary image capture system according to some exemplary embodiments of the present disclosure;

FIG. 2 illustrates a flowchart of an exemplary operation of an exemplary image recording system that that can be implemented within the exemplary image capture system according to some exemplary embodiments of the present disclosure;

FIG. 3 illustrates a simplified block diagram of the exemplary image recording system that that can be implemented within the exemplary image capture system according to some exemplary embodiments of the present disclosure;

FIG. 4 illustrates a pictorial representation of an exemplary striping of digital image data according to some exemplary embodiments of the present disclosure;

FIG. 5 illustrates a pictorial representation of an exemplary distribution of pixel data on an exemplary pixel block-by-pixel block basis according to some exemplary embodiments of the present disclosure;

FIG. 6 illustrates a pictorial representation of an exemplary distribution of pixel data on an exemplary color-by-color basis according to some exemplary embodiments of the present disclosure;

FIG. 7 illustrates a simplified block diagram of an exemplary computer system that can be implemented within the exemplary image capture system and/or the exemplary image projection system according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion.

### Overview

Systems, methods, and apparatuses can store digital image data that is related to an image, or a series of images, commonly visualized as video. These systems, methods, and apparatuses can store the digital image data as unprocessed digital image data in a raw image format that includes color information, for example, luminance and/or chrominance color components of YUV color model and/or red, green, and/or blue color components of a red, green, blue (RGB) color model to provide some examples, for each pixel of the image. These systems, methods, and apparatuses can stripe the digital image data into multiple blocks of image data and can, thereafter, partition the multiple blocks of image data into multiple blocks of pixel data. These systems, methods, and apparatuses can distribute the multiple blocks of pixel data across multiple memory modules that can operate in parallel to improve read and/or write performance.

### Exemplary Image Capture System for Capturing Images

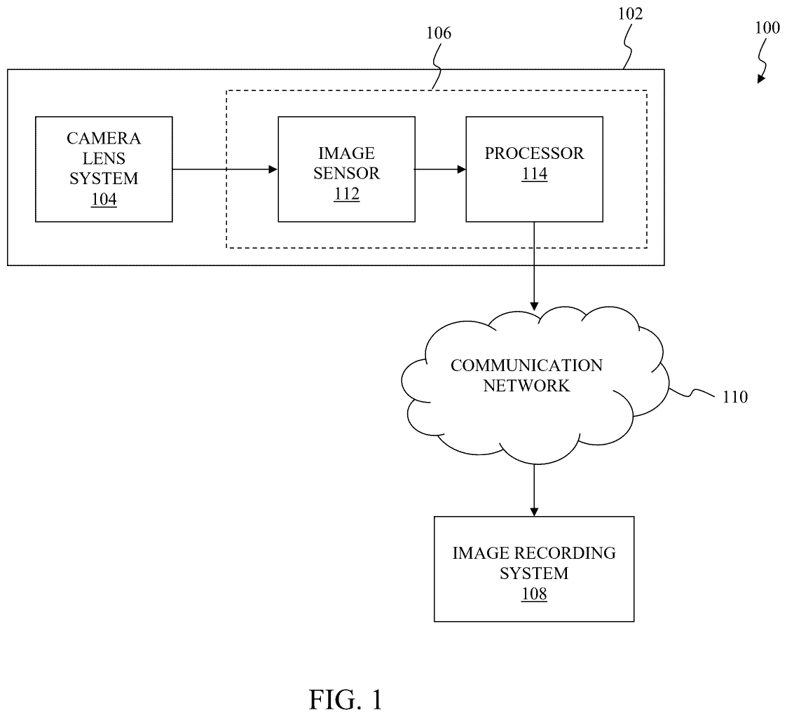

FIG. 1 illustrates a simplified block diagram of an exemplary image capture system according to some exemplary embodiments of the present disclosure. As to be described in further detail below, an image capture system 100 can store digital image data that is related to an image, or a series of images, commonly visualized as video, that is captured by the image capture system 100. In some embodiments, the image capture system 100 can store the digital image data as unprocessed digital image data in a raw image format that includes color information, for example, luminance and/or chrominance color components of YUV color model and/or red, green, and/or blue color components of a red, green, blue (RGB) color model to provide some examples, for each pixel of the image. In these embodiments, the image capture system 100 can stripe the digital image data into multiple blocks of image data and can, thereafter, partition the multiple blocks of image data into multiple blocks of pixel data. In these embodiments, the image capture system 100 can distribute the multiple blocks of pixel data across different groups of memory modules from among multiple memory modules of the image capture system 100. In some embodiments, the multiple memory modules can operate in parallel to improve read and/or write performance of the image capture system 100. As illustrated in FIG. 1, the image capture system 100 can include a camera system 102, having a camera lens system 104 and a camera housing 106, which can be communicatively coupled to an image recording system 108 via a communication network 110. Although the image capture system 100 is illustrated in FIG. 1 as including multiple, discrete devices, those skilled in the relevant art(s) will recognize that one of more of these devices can be combined without departing from the spirit and scope of the present disclosure. For example, the camera system 102 can include the camera lens system 104, the camera housing 106, and/or the image recording system 108 as a single discrete device without the communication network 110 as will be apparent to those skilled in the relevant art(s) without departing from the spirit and scope of the present disclosure.

In the exemplary embodiment illustrated in FIG. 1, the camera lens system 104 projects light that is related to the image, for example, a scene, within its field of view onto an image sensor 112 of the camera housing 106 that is to be described in further detail below. In some embodiments, the camera lens system 104 can focus, for example, converge, the light that is captured onto the image sensor 112. For example, the camera lens system 104 can focus the light that is reflected from one or more physical objects within, for example, the scene, onto the image sensor 112. In some embodiments, the camera lens system 104 can include a simple single lens; however, more complicated compound lenses, such as doublet lenses, triplet lenses, and/or achromatic lenses, are possible as will be apparent to those skilled in the relevant art(s) without departing from the spirit and scope of the present disclosure. In these embodiments, the single lens and/or the compound lenses can be implemented using glass, crystal, and/or plastic, such as acrylic to provide an example. In some embodiments, the compound lenses can be configured and arranged to form an ultra-wide-angle lens, such as a fisheye lens that produces strong visual distortion intended to create a hemispherical image and/or a rectilinear lens with little or no barrel or pincushion distortion that yields images where straight features, such as the edges of walls of buildings, appear with straight lines, as opposed to being curved as with the fisheye lens to provide some examples.

The camera housing 106 captures the light that is focused by the camera lens system 104 onto the image sensor 112 to provide digital image data that is associated with the image. In the exemplary embodiment illustrated in FIG. 1, the camera housing 106 can include the image sensor 112 and a processor 114. Generally, the image sensor 112 converts the light, namely the photons, which is focused onto the image sensor 112 by the camera lens system 104 into electrical signals. In some embodiments, the image sensor 112 can convert the electrical signals from a representation in the analog signal domain to a representation in the digital signal domain to provide the digital image data to be stored by the image recording system 108 as to be described in further detail below. In some embodiments, the image sensor 112 can include small picture elements, also referred to as pixels, which can include light sensitive elements, micro lenses, and/or micro electrical components to provide some examples. In some embodiments, the pixels can be configured and arranged as a series of m-rows and a series of n-columns to form an array of pixels, for example, a square array of pixels. In these embodiments, the image sensor 112 can include 18,000 rows of pixels and 18,000 n-columns of pixels to form an 18,000 by 18,000 square array of pixels. In some embodiments, the image sensor 112 can be implemented as a charge-coupled device (CCD) or an active-pixel sensor that can be fabricated in complementary metal-oxide-silicon (CMOS) and/or n-type metal-oxide-silicon (NMOS) technologies. In some embodiments, the image sensor 112 can be implemented as a color sensor that includes a color mask, such as a Bayer filter mosaic to provide an example, that absorbs undesired color wavelengths so that each pixel of the image sensor 112 is sensitive to a specific color wavelength and/or a monochromatic sensor without the color mask so that each pixel of the image sensor 112 is sensitive to all visible light wavelengths. In these embodiments, the digital image data can include color information, for example, luminance and/or chrominance color components of YUV color model and/or red, green, and/or blue color components of a RGB color model to provide some examples, of each pixel of the image sensor 112.

The processor 114 can provide the digital image data that is developed by the image sensor 112 to the image recording system 108. In some embodiments, the processor 114 can read the digital image data in a raw image format row-wise, namely, along the series of m-rows, and/or column-wise, namely, along the series of n-columns, from the image sensor 112. In these embodiments, the processor 114 can simultaneously read multiple rows from among the series of m-rows and/or multiple columns from among the series of n-columns of the digital image data in the raw image format. In some embodiments, the processor 114 can insert row and/or column markers into the digital image data in the raw image format. In these embodiments, the row and/or column markers can be used to correlate the digital image data in the raw image format to the image that is projected onto the image sensor 112. In some embodiments, the processor 114 can provide the digital image data to the image recording system 108 in the raw image format. In these embodiments, the raw image format includes the color information of the image as read from the image sensor 112. Because there are many different designers and manufacturers of camera systems and/or image sensors, there are many different types of raw image formats. Some of the more common raw image formats include Digital Negative Image (.DNI), Canon Raw 2 Image File (.CR2), Nikon Electronic Format RAW Image (.NEF), and Sony Alpha Raw Digital Camera Image (.ARW) to provide some examples. In some embodiments, the raw image format can be used by the camera system 102 to provide high image quality images that can accommodate vast shades of color depth, for example, between 4,096 and 65,535 shades of color, and a wide dynamic range from shadows to highlights. In some embodiments, the processor 114 can format the digital image data for transmission to the image recording system 108 over the communication network 110.

In some embodiments, the processor 114 can reconstruct the image in an image file format from the digital image data from the digital image data and thereafter provide the image to the image recording system 108. In these embodiments, the image file format can include Joint Photographic Experts Group (JPEG) image file format, Exchangeable Image File Format (EXIF), Tagged Image File Format (TIFF), Graphics Interchange Format (GIF), bitmap image file (BMP) format, or Portable Network Graphics (PNG) image file format to provide some examples. In these embodiments, the processor 114 can implement one or more digital image processing techniques, also referred to as digital picture processing techniques, to process the digital image data that are developed by the image sensor 112 to reconstruct the image from the digital image data. In some embodiments, the one or more digital image processing techniques can include decoding, demosaicing, defective pixel removal, white balancing, noise reduction, color translation, tone reproduction, compression, removal of systematic noise, dark frame subtraction, optical correction, contrast manipulation, unsharp masking, and/or any other suitable well known digital image processing technique that will be apparent to those skilled in the relevant art(s) without departing from the spirit and scope of the present disclosure. In some embodiments, the processor 114 can format the digital image data and/or the image for transmission to the image recording system 108 over the communication network 110. In some embodiments, the processor 114 can compress the digital image data and/or the image using, for example, lossless compression techniques, such as Lempel-Ziv based lossless compression techniques, and/or lossy compression techniques, such as discrete cosine transform (DCT) based lossy compression techniques. In some embodiments, the processor 114 can include, or be coupled to, an electrical-to-optical converter to transform the digital image data from electrical signals to optical signals for transmission over a fiber optic network.

The image recording system 108 can receive the digital image data in the raw image format and/or the image reconstructed from the digital image data in the image file format provided by the camera system 102. In some embodiments, the image recording system 108 can include, or be coupled to, an electrical-to-optical converter to transform the digital image data from optical signals to electrical signals. In the exemplary embodiment illustrated in FIG. 1, the image recording system 108 can store the digital image data as unprocessed digital image data in the raw image format into multiple memory modules. In these embodiments, the image recording system 108 can separate the digital image data into multiple blocks of image data and can distribute these blocks of image data across multiple memory modules within the image recording system 108 in a technique referred to as image data striping. In these embodiments, the multiple memory modules can include, but are not limited to, read only memory (ROM); random access memory (RAM); magnetic disk storage media; optical storage media; flash memory devices; and/or others to provide some examples. Alternately, or in addition to, the multiple memory modules can include hard disk drives, for example, solid-state drives, floppy disk drives along with associated removable media, CD-ROM drives, optical drives, flash memories, and/or removable media cartridges.

As part of this image data striping, the image recording system 108 can separate, or stripe, the digital image data into multiple blocks of image data. In some embodiments, the image recording system 108 can stripe the digital image data along the series of m-rows and/or the series of n-columns of the image sensor 112. As described above, the image sensor 112 can include pixels that can be configured and arranged as the series of m-rows and the series of n-columns to form the array of pixels. In some embodiments, the image recording system 108 can stripe the digital image data from operation 202 row-wise along the series of m-rows to provide k-blocks of image data with each block of image data from among the k-blocks of image data including m/k-rows of pixels and n-columns of pixels. Alternatively, or in addition to, the image recording system 108 can stripe the digital image data from operation 202 column-wise along the series of n-columns to provide the k-blocks of image data with each block of image data from among the k-blocks of image data including m-rows of pixels and n/k-columns of pixels.

As part of this image data striping, the image recording system 108 can sequentially distribute the multiple blocks of image data across different groups of memory modules from among the multiple memory modules. In these embodiments, the image recording system 108 can sequentially distribute the color information of the pixels from among the multiple blocks of image data. In these embodiments, the image recording system 108 can sequentially distribute the k-blocks of image data across the k-groups of memory modules in parallel. In some embodiments, the image recording system 108 can sequentially distribute the k-blocks of image data, for example, the color information of the pixels from among the k-blocks of image data, across the k-groups of memory modules in a round-robin fashion. Typically, the round-robin fashion sequentially cycles through the multiple memory modules one after another; however, those skilled in the relevant art(s) will recognize that the round-robin manner may cycle through the multiple memory modules in any suitable order without departing from the spirit and scope of the present disclosure. In some embodiments, the image recording system 108 can partition the k-blocks of image data into multiple blocks of pixel data having a series of a-rows from among the series of m-rows and a series of b-columns from among the series of n-columns. In these embodiments, the image recording system 108 can sequentially distribute the multiple blocks of pixel data, for example, the color information of the pixels from among the multiple blocks of pixel data, across corresponding groups of memory modules from among the k-groups of memory modules on a pixel block-by-pixel block basis. In some embodiments, the pixel block-by-pixel block basis represents a location-based distribution of the color information of the pixels from among the multiple blocks of pixel data across the corresponding groups of memory modules in relation to their relative location, or position, within the k-blocks of image data. In these embodiments, the image recording system 108 can sequentially distribute the multiple blocks of pixel data one after another across the corresponding groups of memory modules. For example, the image recording system 108 can sequentially distribute a first block of pixel data from among the multiple blocks of pixel data to a first memory module from among a group of memory modules, an adjacent, or a neighboring, second block of pixel data from among the multiple blocks of pixel data to a second memory module from among the group of memory modules, an adjacent, or a neighboring, and/or third block of pixel data from among the multiple blocks of pixel data to a third memory module from among the group of memory modules, among others.

Alternatively, in addition to, the image recording system 108 can sequentially distribute the multiple blocks of pixel data, for example, the color information of the pixels from among the multiple blocks of pixel data, across corresponding groups of memory modules from among the k-groups of memory modules on a color-by-color basis, for example, luminance and/or chrominance color components of YUV color model and/or red, green, and/or blue color components of a red, green, blue (RGB) color model to provide some examples. In some embodiments, the color-by-color basis represents a color component-based distribution of the color information of the pixels from among the multiple blocks of pixel data, multiple blocks of pixel data across the corresponding groups of memory modules in relation to their color components, for example, luminance and/or chrominance color components of YUV color model and/or red, green, and/or blue color components of a red, green, blue (RGB) color model to provide some examples. In these embodiments, the image recording system 108 can sequentially distribute the color components of the multiple blocks of pixel data one after another across the corresponding groups of memory modules. For example, the image recording system 108 can sequentially distribute a red colored pixel from among a block of pixel data from among the multiple blocks of pixel data to a first memory module from among a group of memory modules, a first green colored pixel from among the block of pixel data to a second memory module from among the group of memory modules, a blue colored pixel from among the block of pixel data to a third memory module from among the group of memory modules, and/or second green colored pixel from among the block of pixel data to a fourth memory module from among the group of memory modules, among others.

The communication network 110 communicatively couples the camera system 102 and the image recording system 108. The communication network 110 can implemented as a wireless communication network, a wireline communication network, and/or any combination thereof that will be apparent to those skilled in the relevant art(s) without departing from the spirit and scope of the present disclosure. In some embodiments, the communication network 110 can include one or more guided transmission mediums, such as one or more twisted pair cables, one or more Ethernet cables, one or more coaxial cables, and/or one or more optical fiber cables to provide some examples, to communicatively couple the camera system 102 and the image recording system 108. In these embodiments, the communication network 110 can include a hybrid fiber-coaxial (HFC) network that combines the one or more optical fiber cables and the one or more coaxial cables to communicatively couple the camera system 102 and the image recording system 108. In some embodiments, the communication network 110 can include one or more unguided transmission mediums, such as one or more radio links, one or more microwave links, one or more satellite links, one or more Bluetooth links, one or more Wi-Fi links to provide some examples, to communicatively couple the camera system 102 and the image recording system 108.

### Exemplary Image Recording System That Can be Implemented Within the Exemplary Image Capture System

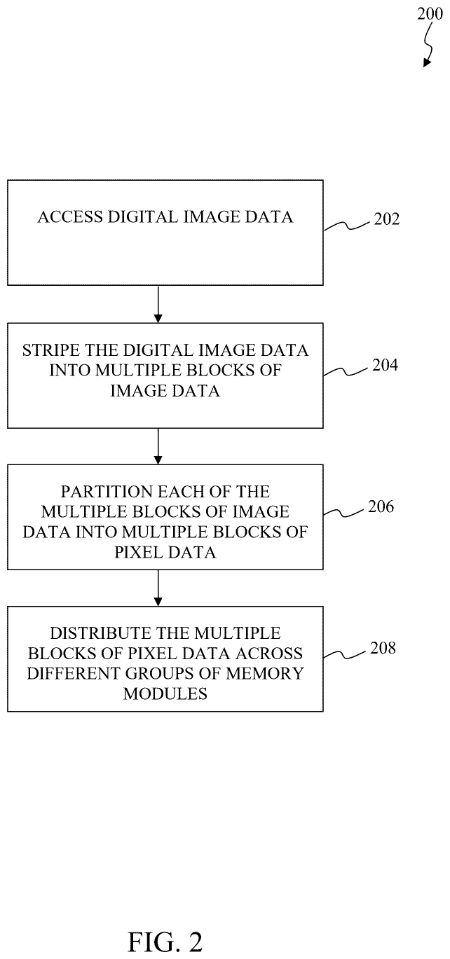

FIG. 2 illustrates a flowchart of an exemplary operation of an exemplary image recording system that that can be implemented within the exemplary image capture system according to some exemplary embodiments of the present disclosure. The disclosure is not limited to this operational description. Rather, it will be apparent to ordinary persons skilled in the relevant art(s) that other operational control flows are within the scope and spirit of the present disclosure. An operational control flow 200 as illustrated in FIG. 2 can be executed by one or more computer systems, such as the image recording system 108 as described above to provide an example. The following discussion describes an exemplary operational control flow 200 for storing digital image data, such as the digital image data as described above, memory modules within, for example, the image recording system 108 as described above to provide an example.

At operation 202, the operational control flow 200 accesses the digital image data. In some embodiments, the operational control flow 200 can receive the digital image data in the raw image format provided by a camera system, such as the camera system 102 as described above to provide an example. And as described above, the camera system can onto an image sensor, such as the image sensor 112 as described above to provide an example, to provide the digital image data. In some embodiments, the image sensor can include small picture elements, also referred to as pixels, which can include light sensitive elements, micro lenses, and/or micro electrical components to provide some examples. In these embodiments, the pixels can be configured and arranged as a series of m-rows and a series of n-columns to form an array of pixels, for example, a square array of pixels. In some embodiments, the operational control flow 200 can read the digital image data in the raw image format row-wise, namely, along the series of m-rows, and/or column-wise, namely, along the series of n-columns, that is captured by an image sensor of the camera system in a substantially similar manner as described above to access the digital image data.

At operation 204, the operational control flow 200 stripes the digital image data from operation 202 into multiple blocks of image data. In some embodiments, the operational control flow 200 can stripe the digital image data from operation 202 along the series of m-rows and/or the series of n-columns. In these embodiments, the operational control flow 200 can stripe the digital image data from operation 202 row-wise, namely, along the series of m-rows, and/or column-wise, along the series of n-columns. For example, the operational control flow 200 can stripe the digital image data from operation 202 row-wise to provide the k-blocks of image data with each block of image data from among the k-blocks of image data including a series of m/k-rows of pixels and the series of n-columns of pixels. Otherwise in this example, the operational control flow 200 can stripe the digital image data from operation 202 column-wise to provide the k-blocks of image data with each block of image data from among the k-blocks of image data including the series of m-rows of pixels and a series of n/k-columns of pixels.

At operation 206, the operational control flow 200 partitions multiple blocks of image data from operation 204 into multiple blocks of pixel data. In some embodiments, the operational control flow 200 can partition the k-blocks of image data from operation 204 into the multiple blocks of pixel data with each block of pixel data from among the multiple blocks of pixel data including a series of a-rows from among the series of m-rows and a series of b-columns from among the series of n-columns. For example, the operational control flow 200 can partition the series of m/k-rows of pixels and the series of n-columns of pixels of the k-blocks of image data from operation 202 into the multiple blocks of pixel data with each block of pixel data from among the multiple blocks of pixel data including the series of a-rows and the series of b-columns. As another example, the operational control flow 200 can partition the series of m-rows of pixels and the series of n/k-columns of pixels of each the k-blocks of image data from operation 202 into the multiple blocks of pixel data with each block of pixel data from among the multiple blocks of pixel data including the series of a-rows and the series of b-columns.

At operation 208, the operational control flow 200 distributes the multiple blocks of pixel data from operation 206 across different groups of memory modules from among multiple memory modules of the image recording system 108. In some embodiments, the operational control flow 200 can distribute the color information of the pixels from among the multiple blocks of pixel data from operation 206 across the different groups of memory modules. In some embodiments, the multiple memory modules can include, but are not limited to, read only memory (ROM); random access memory (RAM); magnetic disk storage media; optical storage media; flash memory devices; and/or others to provide some examples. Alternately, or in addition to, the multiple memory modules can include hard disk drives, for example, solid-state drives, floppy disk drives along with associated removable media, CD-ROM drives, optical drives, flash memories, and/or removable media cartridges. In some embodiments, the operational control flow 200 can sequentially distribute the color information of the pixels from among the series of a-rows and the series of b-columns of each block of pixel data across a corresponding group of memory modules from among the k-groups of memory modules on a pixel block-by-pixel block basis. Alternatively, in addition to, the image recording system 108 can sequentially distribute the color information of the pixels from among the series of a-rows and the series of b-columns of each block of pixel data across a corresponding group of memory modules from among the k-groups of memory modules on a color-by-color basis, for example, red, green, and/or blue color components of the RGB color model. The pixel block-by-pixel block basis and the color-by-color basis are to be described in further detail below. In some embodiments, the operational control flow 200 can distribute the multiple blocks of pixel data from operation 206 across the different groups of memory modules in parallel to improve read and/or write performance.

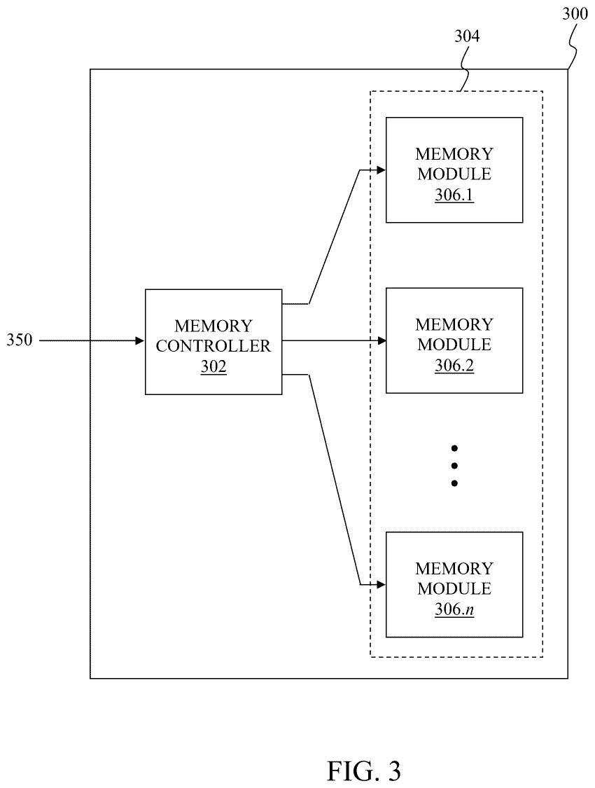

FIG. 3 illustrates a simplified block diagram of the exemplary image recording system that that can be implemented within the exemplary image capture system according to some exemplary embodiments of the present disclosure. As to be described in further detail below, an image recording system 300 can receive digital image data that is related to a series of images, commonly visualized as video, that is captured from a camera system, such as the camera system 102 as described above. As to be described in further detail below, the image recording system 300 can store the digital image data. In some embodiments, the image recording system 300 can store the digital image data as unprocessed digital image data in a raw image format that includes color information, for example, luminance and/or chrominance color components of YUV color model and/or red, green, and/or blue color components of a red, green, blue (RGB) color model to provide some examples, for each pixel of the image. In some embodiments, the image recording system 300 can stripe the digital image data into multiple blocks of image data and can, thereafter, partition the multiple blocks of image data into multiple blocks of pixel data. In these embodiments, the image recording system 300 can distribute the multiple blocks of pixel data across multiple memory modules. As illustrated in FIG. 3, the image recording system 300 can include a memory controller 302 and a memory storage 304. In some embodiments, the memory controller 302 can be implemented as a standalone, or a discrete device, and/or can be incorporated within or coupled to another electrical, mechanical, and/or electromechanical device, or host device, such as a microprocessor to provide an example to from an integrated memory controller (IMC). The image recording system 300 can represent an exemplary embodiment of the image recording system 108 as described above.

The memory controller 302 controls the overall configuration and/or operation of the image recording system 300 in storing the digital image data 350. In the exemplary embodiment illustrated in FIG. 3, the memory controller 302 receives the digital image data 350 from, for example, a camera system, such as the camera system 102 as described above, in the raw image format. In some embodiments, the memory controller 302 can read the digital image data 350 in the raw image format row-wise, namely, along the series of m-rows, and/or column-wise, namely, along the series of n-columns, that is captured by an image sensor of the camera system in a substantially similar manner as described above to receive the digital image data 350. After receiving the digital image data 350, the memory controller 302 can stripe the digital image data 350 into multiple blocks of image data. In some embodiments, the memory controller 302 can stripe the digital image data 350 along the series of m-rows and/or the series of n-columns in a substantially similar manner as described above. And after striping the digital image data 350, the memory controller 302 can partition the multiple blocks of image data into multiple blocks of pixel data. In some embodiments, the memory controller 302 can partition the k-blocks of image data into the multiple blocks of pixel data with each block of pixel data from among the multiple blocks of pixel data including a series of a-rows from among the series of m-rows and a series of b-columns from among the series of n-columns in a substantially similar manner as described above. And after partitioning the k-blocks of image data, the memory controller 302 can distribute the multiple blocks of pixel data across different groups of memory modules from among multiple memory modules 306.1 through 306.n of the memory storage 304. In some embodiments, the memory controller 302 can sequentially distribute the k-blocks of image data across k-groups of memory modules in parallel. In some embodiments, the memory controller 302 can sequentially distribute the k-blocks of image data across the k-groups of memory modules in a round-robin fashion. Typically, the round-robin fashion sequentially cycles through the multiple memory modules one after another; however, those skilled in the relevant art(s) will recognize that the round-robin manner may cycle through the multiple memory modules in any suitable order without departing from the spirit and scope of the present disclosure. In some embodiments, the memory controller 302 can partition the k-blocks of image data into multiple blocks of pixel data having a series of a-rows from among the series of m-rows and a series of b-columns from among the series of n-columns. In these embodiments, the memory controller 302 can sequentially distribute pixels from among the series of a-rows and the series of b-columns of each block of pixel data across a corresponding group of memory modules from among the k-groups of memory modules on a pixel block-by-pixel block basis. Alternatively, in addition to, the memory controller 302 can sequentially distribute pixels from among the series of a-rows and the series of b-columns of each block of pixel data across a corresponding group of memory modules from among the k-groups of memory modules on a color-by-color basis, for example, red, green, and/or blue color components of the RGB color model. The pixel block-by-pixel block basis and the color-by-color basis are to be described in further detail below.

The memory storage 304 stores the digital image data 350. As illustrated in FIG. 3, the memory storage includes the memory modules 306.1 through 306.n. In the exemplary embodiment illustrated in FIG. 3, the memory modules 306.1 through 306.n can include, but are not limited to, read only memory (ROM); random access memory (RAM); magnetic disk storage media; optical storage media; flash memory devices; and/or others to provide some examples. Alternately, or in addition to, the multiple memory modules can include hard disk drives, for example, solid-state drives, floppy disk drives along with associated removable media, CD-ROM drives, optical drives, flash memories, and/or removable media cartridges. In some embodiments, the memory modules 306.1 through 306.n can be logically assigned between different groups of memory modules from among the k-groups of memory modules. For example, the memory modules 306.1 through 306.n can be logically assigned between a first group of memory modules that corresponds to a first group of m/k-rows from among the series of m-rows of the image sensor, a second group of memory modules that corresponds to a second group of m/k-rows from among the series of m-rows of the image sensor, and/or a k^{th} group of memory modules that corresponds to k^{th} group of m/k-rows from among the series of m-rows of the image sensor. As another example, the memory modules 306.1 through 306.n can be logically assigned between a first group of memory modules that corresponds to a first group of n/k-columns from among the series of n-columns of the image sensor, a second group of memory modules that corresponds to a second group of n/k-columns from among the series of n-columns of the image sensor, and/or a k^{th} group of memory modules that corresponds to k^{th} group of n/k-columns from among the series of n-columns of the image sensor. In these examples, the memory controller 302 can sequentially distribute the pixels from among the series of a-rows and the series of b-columns of each block of pixel data between the first group of memory modules, the second group of memory modules, and the first group of memory modules on the pixel block-by-pixel block basis and/or the color-by-color basis.

### Exemplary Storing Of Exemplary Digital Image Data of the Present Disclosure

As described above, the digital image data can be stored as unprocessed digital image data in a raw image format that includes color information, for example, luminance and/or chrominance color components of YUV color model and/or red, green, and/or blue color components of a red, green, blue (RGB) color model to provide some examples, for each pixel of the image. And as described above, the digital image data can be striped into multiple blocks of image data and the multiple blocks of image data can, thereafter, be partitioned into multiple blocks of pixel data. And as described above, the multiple blocks of pixel data can be distributed across different groups of memory modules from among multiple memory modules. The discussion to follow is to further describe various exemplary embodiments for this striping, partitioning, and/or distributing. Those skilled in the relevant art(s) will recognize that these exemplary embodiments are not meant to be limiting. Rather, those skilled in the relevant art(s) will recognize that one or more these exemplary embodiments can be combined with other embodiments without departing from the spirit and scope of the present disclosure.

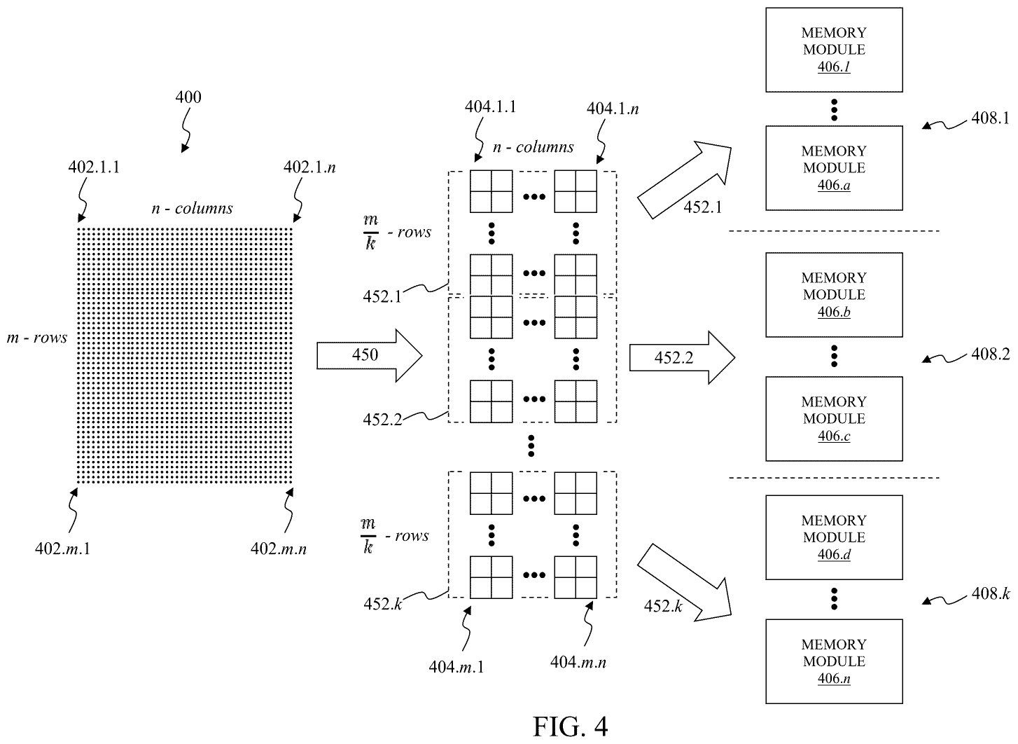

FIG. 4 illustrates a pictorial representation of an exemplary striping of digital image data according to some exemplary embodiments of the present disclosure. In the exemplary embodiment illustrated in FIG. 4, an exemplary computer system can, such as the image recording system 108 and/or the image recording system 300 as described above to provide some examples, stores digital image data 450 as unprocessed digital image data in a raw image format. As part of this storing, the exemplary computer system can stripe digital image data 450 into k-blocks of image data 452.1 through 452.k as to be described in further detail below. As illustrated in FIG. 4, the exemplary computer system can access the digital image data 450. In some embodiments, an image sensor 400 can include small picture elements, also referred to as pixels 402.1.1 through pixels 402.m.n, which can include light sensitive elements, micro lenses, and/or micro electrical components to provide some examples. In these embodiments, the pixels 402.1.1 through pixels 402.m.n can be configured and arranged as a series of m-rows and a series of n-columns to form an array of pixels, for example, a square array of pixels. In these embodiments, the pixels 402.1.1 through pixels 402.m.n can be read row-wise, namely, along the series of m-rows, and/or column-wise, namely, along the series of n-columns, in a substantially similar manner as described above to provide the digital image data 450. In these embodiments, the digital image data 450 can include color information, for example, red (R), green (G), and/or blue (B) color components of a RGB color model to provide some examples, for the pixels 402.1.1 through pixels 402.m.n. In some embodiments, the pixels 402.1.1 through pixels 402.m.n can be read row-wise, namely, along the series of m-rows, and/or column-wise, namely, along the series of n-columns, in a substantially similar manner as described above to provide the digital image data 450 in a raw image format. Because there are many different designers and manufacturers of camera systems and/or image sensors, there are many different types of raw image formats. Some of the more common raw image formats include Digital Negative Image (.DNI), Canon Raw 2 Image File (.CR2), Nikon Electronic Format RAW Image (.NEF), and Sony Alpha Raw Digital Camera Image (.ARW) to provide some examples.

As illustrated in FIG. 4, the exemplary computer system can stripe the digital image data 450 into the k-blocks of image data 452.1 through 452.k. In some embodiments, the exemplary computer system can stripe the digital image data 450 along the series of m-rows and/or the series of n-columns of the image sensor 400 to provide the k-blocks of image data 452.1 through 452.k. As described above, the digital image data 450 can include the color information, for example, red (R), green (G), and/or blue (B) color components of a RGB color model to provide some examples, for the pixels 402.1.1 through pixels 402.m.n. In these embodiments, the exemplary computer system can analyze the digital image data 450 to identify color pixels 404.1.1 through pixels 404.m.n, for example, the red (R), the green (G), and/or the blue (B) color components for the pixels 402.1.1 through pixels 402.m.n, from the digital image data 450. For example, the exemplary computer system can utilize the row and/or the column markers as described above, within the digital image data 450 to assist in identifying the color pixels 404.1.1 through pixels 404.m.n. Although the color pixels 404.1.1 through pixels 404.m.n are illustrated as being arranged in the series of m-rows and/or the series of n-columns, this is for exemplary purposes only and not limiting. Those skilled in the relevant art(s) will recognize that the color pixels 404.1.1 through pixels 404.m.n can be arranged in any suitable one-dimensional array or vector, or multi-dimensional array or vector, without departing from the spirit and scope of the present disclosure. In the exemplary embodiment illustrated in FIG. 4, the exemplary computer system can stripe the color pixels 404.1.1 through pixels 404.m.n row-wise, namely, along the series of m-rows. Although not illustrated in FIG. 4, the exemplary computer system can stripe the color pixels 404.1.1 through pixels 404.m.n column-wise, namely, along the series of n-columns in a substantially similar manner as to be described in further detail below. In some embodiments, the exemplary computer system can stripe the color pixels 404.1.1 through pixels 404.m.n row-wise to provide the k-blocks of image data 452.1 through 452.k. In these embodiments, each block of image data from among the k-blocks of image data 452.1 through 452.k can include a series of m/k-rows of pixels and the series of n-columns of pixels to form an m/k by n array of image data. For example, the exemplary computer system can stripe the color pixels 404.1.1 through pixels 404.m.n row-wise to provide three blocks of image data 452.1 through 452.3. In this example, the block of image data 452.1 represents pixels 402.1.1 through pixels 402.m.n within a top-third of the rows from among the series of m-rows of the image sensor 400, the block of image data 452.2 represents pixels 402.1.1 through pixels 402.m.n within a middle-third of the rows from among the series of m-rows of the image sensor 400, and the block of image data 452.3 represents pixels 402.1.1 through pixels 402.m.n within a bottom-third of the rows from among the series of m-rows of the image sensor 400.

After the digital image data 450 is striped into the k-blocks of image data 452.1 through 452.k, the exemplary computer system distributes the k-blocks of image data 452.1 through 452.k across different k-groups of memory modules 408.1 through 408.k from among memory modules 406.1 through 406.n. In some embodiments, the exemplary computer system distributes the color information of the pixels from among the k-blocks of image data 452.1 through 452.k across different k-groups of memory modules 408.1 through 408.k from among memory modules 406.1 through 406.n. As illustrated in FIG. 4, the exemplary computer system can distribute a first block of image data 452.1 across a first group of memory modules 408.1 having the memory modules 406.1 through 406.a, a second block of image data 452.2 across a second group of memory modules 408.2 having the memory modules 406.b through 406.c, and/or a k^{th}_block of image data 452.k across a k^{th} group of memory modules 408.k having the memory modules 406.d through 406.n. In some embodiments, the memory modules 406.1 through 406.n can include, but are not limited to, read only memory (ROM); random access memory (RAM); magnetic disk storage media; optical storage media; flash memory devices; and/or others to provide some examples. Alternately, or in addition to, the memory modules 406.1 through 406.n can include hard disk drives, for example, solid-state drives, floppy disk drives along with associated removable media, CD-ROM drives, optical drives, flash memories, and/or removable media cartridges. In some embodiments, the exemplary computer system can sequentially distribute the color information of the pixels from among the k-blocks of image data 452.1 through 452.k on a pixel block-by-pixel block basis as to be described in further detail below. Alternatively, in addition to, the exemplary computer system can sequentially distribute the color information of the pixels from among the k-blocks of image data 452.1 through 452.k on a color-by-color basis, for example, red, green, and/or blue color components of the RGB color model, as to be described in further detail below.

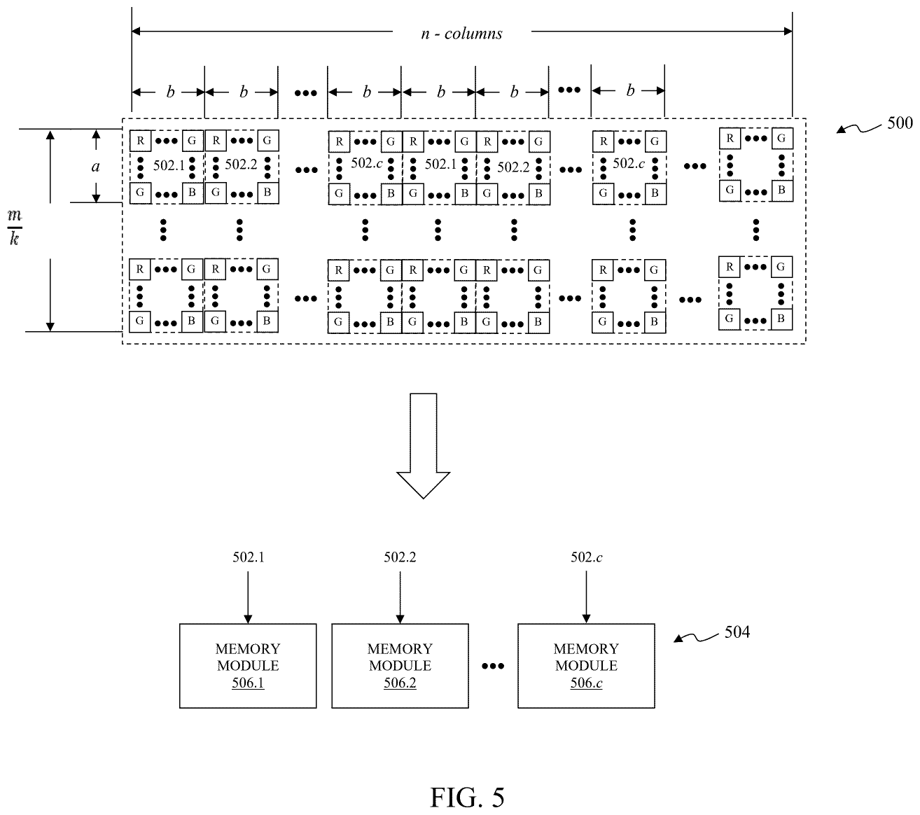

FIG. 5 illustrates a pictorial representation of an exemplary distribution of pixel data on an exemplary pixel block-by-pixel block basis according to some exemplary embodiments of the present disclosure. In the exemplary embodiment illustrated in FIG. 5, an exemplary computer system can, such as the image recording system 108 and/or the image recording system 300 as described above to provide some examples, stores digital image data as unprocessed digital image data in a raw image format. As part of this storing, the exemplary computer system can stripe digital image data into multiple blocks of image data in a substantially similar manner as described above. And as part of this storing, the exemplary computer system can partition the multiple blocks of image data into multiple blocks of pixel data. The discussion of FIG. 5 to follow is to an exemplary partitioning of a block of image data 500, as illustrated in FIG. 5, from among the multiple blocks of pixel data, such as the k-blocks of image data 452.1 through 452.k as described above. In some embodiments, the exemplary partitioning as to be described in further detail below can be simultaneously performed on the multiple blocks of pixel data in parallel to improve read and/or write performance for the exemplary computer system.

As illustrated in FIG. 5, the exemplary computer system can partition the block of image data 500 into multiple c-blocks of pixel data 502.1 through 502.c. In some embodiments, the exemplary computer system can partition the block of image data 500 into the multiple c-blocks of pixel data 502.1 through 502.c with each block of pixel data from among the multiple c-blocks of pixel data 502.1 through 502.c including a series of a-rows from among the series of m-rows and a series of b-columns from among the series of n-columns. In these embodiments, the exemplary computer system can partition the series of m/k-rows of pixels and the series of n-columns of pixels of the block of image data 500 into the multiple c-blocks of pixel data 502.1 through 502.c with each block of pixel data from among the multiple c-blocks of pixel data 502.1 through 502.c including the series of a-rows and the series of b-columns. In some embodiments, each block of pixel data from among the multiple c-blocks of pixel data 502.1 through 502.c can be characterized as forming an a-by-b array of pixel data. In some embodiments, the c-blocks of pixel data 502.1 through 502.c can represent a one-dimensional array of pixel data or a multi-dimensional array of pixel data. In these embodiments, the series of a-rows can be equal in length to the series of b-columns to form a square array of pixel data. In these embodiments, the series of a-rows and/or the series of b-columns can represent an integer multiple of two, namely, an even number, of rows and/or columns, respectively. For example, each block of pixel data from among the c-blocks of pixel data 502.1 through 502.c can be characterized as being a two (2) by two (2) array of pixel data. Alternately, or in addition to, the series of a-rows and/or the series of b-columns can represent an integer multiple of three, namely, an odd number, of rows and/or columns, respectively.

After the block of image data 500 is partitioned into the multiple c-blocks of pixel data 502.1 through 502.c, the exemplary computer system can distribute the multiple c-blocks of pixel data 502.1 through 502.c, for example, the color information of the pixels from among the multiple c-blocks of pixel data 502.1 through 502.c, across memory modules 506.1 through 506.c on the exemplary pixel block-by-pixel block basis. In some embodiments, the memory modules 506.1 through 506.c can represent one or more of the k-groups of memory modules 408.1 through 408.k as described above. In some embodiments, the pixel block-by-pixel block basis represents a location-based distribution of the multiple c-blocks of pixel data across the memory modules 506.1 through 506.c in relation to their relative location, or position, within the block of image data 500. In these embodiments, the exemplary computer system can sequentially distribute the multiple c-blocks of pixel data 502.1 through 502.c across the memory modules 506.1 through 506.c in a round-robin fashion. Typically, the round-robin fashion sequentially cycles through the memory modules 506.1 through 506.c one after another; however, those skilled in the relevant art(s) will recognize that the round-robin manner may cycle through the memory modules 506.1 through 506.c in any suitable order without departing from the spirit and scope of the present disclosure. For example, the exemplary computer system can sequentially distribute the color information of the first blocks of pixel data 502.1 to the memory module 506.1, the color information of the second blocks of pixel data 502.2 to the memory module 506.2, and/or the color information of the c^{th} blocks of pixel data 502.c to the memory module 506.c to cycle through the memory modules 506.1 through 506.c one after another in the round-robin fashion.

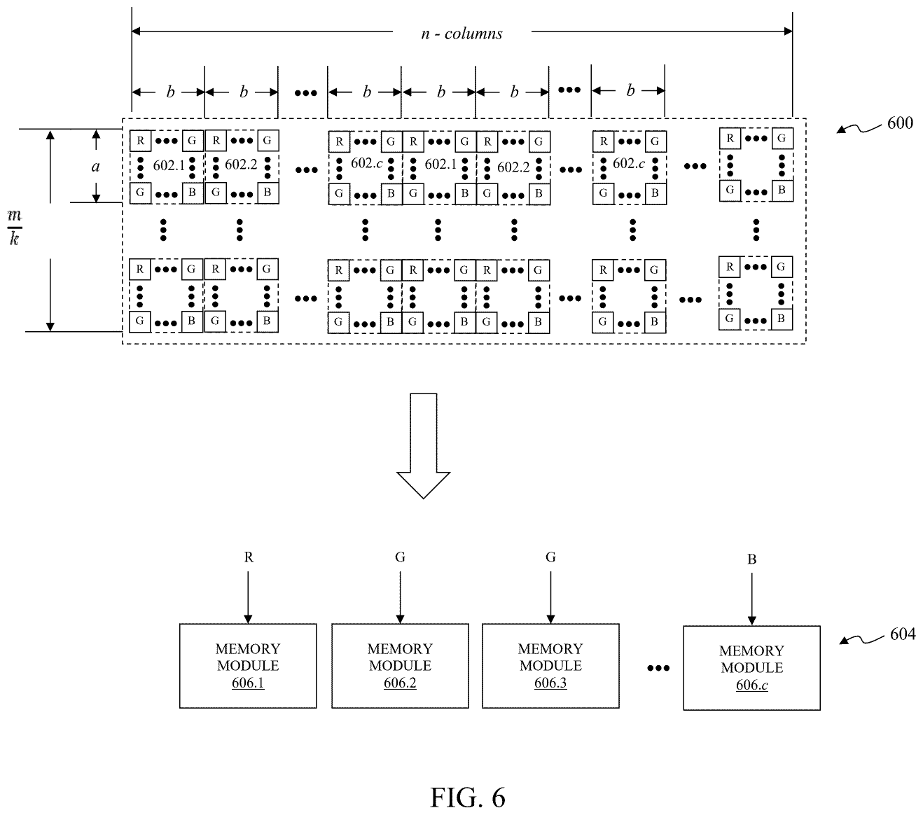

FIG. 6 illustrates a pictorial representation of an exemplary distribution of pixel data on an exemplary color-by-color basis according to some exemplary embodiments of the present disclosure. In the exemplary embodiment illustrated in FIG. 6, an exemplary computer system can, such as the image recording system 108 and/or the image recording system 300 as described above to provide some examples, stores digital image data as unprocessed digital image data in a raw image format. As part of this storing, the exemplary computer system can stripe digital image data into multiple blocks of image data in a substantially similar manner as described above. And as part of this storing, the exemplary computer system can partition the multiple blocks of image data into multiple blocks of pixel data. The discussion of FIG. 6 to follow is to an exemplary partitioning of a block of image data 600, as illustrated in FIG. 6, from among the multiple blocks of pixel data, such as the k-blocks of image data 452.1 through 452.k as described above. In some embodiments, the exemplary partitioning as to be described in further detail below can be simultaneously performed on the multiple blocks of pixel data in parallel to improve read and/or write performance for the exemplary computer system.

As illustrated in FIG. 6, the exemplary computer system can partition the block of image data 600 into multiple c-blocks of pixel data 602.1 through 602.c. In some embodiments, the exemplary computer system can partition the block of image data 600 into the multiple c-blocks of pixel data 602.1 through 602.c with each block of pixel data from among the multiple c-blocks of pixel data 602.1 through 602.c including a series of a-rows from among the series of m-rows and a series of b-columns from among the series of n-columns. In these embodiments, the exemplary computer system can partition the series of m/k-rows of pixels and the series of n-columns of pixels of the block of image data 600 into the multiple c-blocks of pixel data 602.1 through 602.c with each block of pixel data from among the multiple c-blocks of pixel data 602.1 through 602.c including the series of a-rows and the series of b-columns. In some embodiments, each block of pixel data from among the multiple c-blocks of pixel data 602.1 through 602.c can be characterized as forming an a-by-b array of pixel data. In some embodiments, the c-blocks of pixel data 602.1 through 602.c can represent a one-dimensional array of pixel data or a multi-dimensional array of pixel data. In these embodiments, the series of a-rows can be equal in length to the series of b-columns to form a square array of pixel data. In these embodiments, the series of a-rows and/or the series of b-columns can represent an integer multiple of two, namely, an even number, of rows and/or columns, respectively. For example, each block of pixel data from among the c-blocks of pixel data 602.1 through 602.c can be characterized as being a two (2) by two (2) array of pixel data. Alternately, or in addition to, the series of a-rows and/or the series of b-columns can represent an integer multiple of three, namely, an odd number, of rows and/or columns, respectively.

After the block of image data 600 is partitioned into the multiple c-blocks of pixel data 602.1 through 602.c, the exemplary computer system can distribute the multiple c-blocks of pixel data 602.1 through 602.c, for example, the color information of the pixels from among the multiple c-blocks of pixel data 602.1 through 602.c, across memory modules 606.1 through 606.c on the exemplary pixel color-by-color basis. In some embodiments, the memory modules 606.1 through 606.c can represent one or more of the k-groups of memory modules 408.1 through 408.k as described above. In some embodiments, the exemplary color-by-color basis represents a color component-based distribution of the multiple c-blocks of pixel data 602.1 through 602.c across the memory modules 606.1 through 606.c in relation to their color components, for example, red, green, and/or blue color components of a red, green, blue (RGB) color model to provide some examples. In these embodiments, the exemplary computer system can sequentially distribute the color components of the multiple c-blocks of pixel data 602.1 through 602.c across the memory modules 606.1 through 606.c in a round-robin fashion. Typically, the round-robin fashion sequentially cycles through the memory modules 606.1 through 606.c one after another; however, those skilled in the relevant art(s) will recognize that the round-robin manner may cycle through the memory modules 606.1 through 606.c in any suitable order without departing from the spirit and scope of the present disclosure. For example, the exemplary computer system can sequentially distribute the color information of red colored pixels from among the multiple c-blocks of pixel data 602.1 through 602.c to the memory module 506.1, the color information of first green colored pixels from among the multiple c-blocks of pixel data 602.1 through 602.c to the memory module 506.2, the color information of blue colored pixels from among the multiple c-blocks of pixel data 602.1 through 602.c to the memory module 506.3, and/or the color information of second green colored pixels from among the multiple c-blocks of pixel data 602.1 through 602.c to the memory module 506.c, among others.

### Exemplary Computer System That Can be Implemented Within the Exemplary Image Capture System

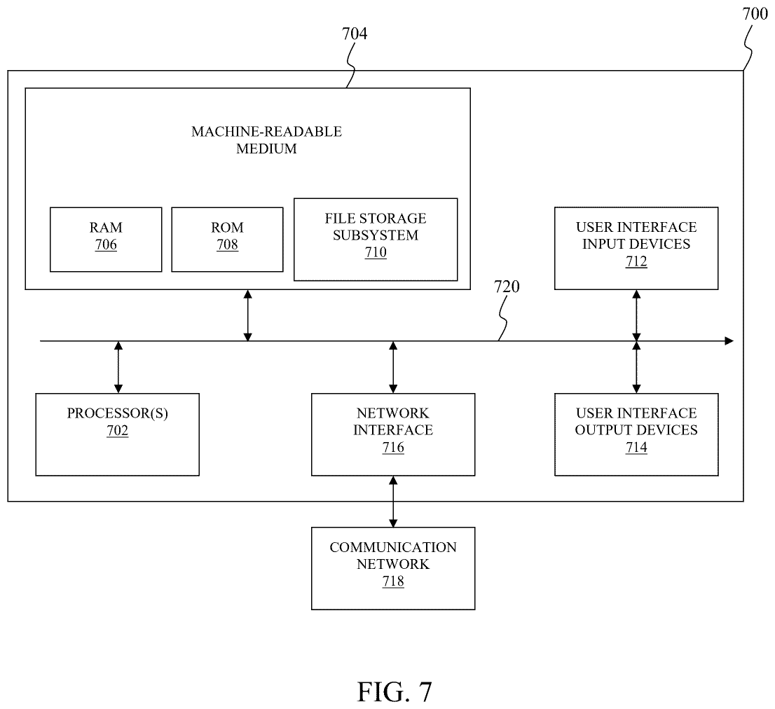

FIG. 7 illustrates a simplified block diagram of an exemplary computer system that can be implemented within the exemplary image capture system and/or the exemplary image projection system according to some exemplary embodiments of the present disclosure. The discussion of FIG. 7 to follow is to describe a computer system 700 that can be implemented within the image capture system 100 as described above and/or the image recording system 300 as described above in FIG. 3.

In the exemplary embodiment illustrated in FIG. 7, the computer system 700 includes one or more processors 702. In some embodiments, the one or more processors 702 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 700 can include an operating system, such as Microsoft's Windows, Sun Microsystems's Solaris, Apple Computer's MacOs, Linux or UNIX. In some embodiments, the computer system 700 can also include a Basic Input/Output System (BIOS) and processor firmware. The operating system, BIOS and firmware are used by the one or more processors 702 to control subsystems and interfaces coupled to the one or more processors 702. In some embodiments, the one or more processors 702 can include the Pentium and Itanium from Intel, the Opteron and Athlon from Advanced Micro Devices, and the ARM processor from ARM Holdings.

As illustrated in FIG. 7, the computer system 700 can include a machine-readable medium 704. In some embodiments, the machine-readable medium 704 can further include a main random-access memory (“RAM”) 706, a read only memory (“ROM”) 708, and/or a file storage subsystem 710. The RAM 1030 can store instructions and data during program execution and the ROM 1032 can store fixed instructions. The file storage subsystem 710 provides persistent storage for program and data files, and may include a hard disk drive, a floppy disk drive along with associated removable media, a CD-ROM drive, an optical drive, a flash memory, or a removable media cartridge.

The computer system 700 can further include user interface input devices 712 and user interface output devices 714. The user interface input devices 712 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 712 can be connected by wire or wirelessly to the computer system 700. Generally, the user interface input devices 712 are intended to include all possible types of devices and ways to input information into the computer system 700. The user interface input devices 712 typically allow a user to identify objects, icons, text and the like that appear on some types of user interface output devices, for example, a display subsystem. The user interface output devices 1020 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 1020 are intended to include all possible types of devices and ways to output information from the computer system 700.

The computer system 700 can further include a network interface 716 to provide an interface to outside networks, including an interface to a communication network 718, and is coupled via the communication network 718 to corresponding interface devices in other computer systems or machines. The communication network 718 may comprise many interconnected computer systems, machines and communication links. These communication links may be wired links, optical links, wireless links, or any other devices for communication of information. The communication network 718 can be any suitable computer network, for example a wide area network such as the Internet, and/or a local area network such as Ethernet. The communication network 718 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 7, the one or more processors 702, the machine-readable medium 704, the user interface input devices 712, the user interface output devices 714, and/or the network interface 716 can be communicatively coupled to one another using a bus subsystem 1020. Although the bus subsystem 1020 is shown schematically as a single bus, alternative embodiments of the bus subsystem may use multiple busses. For example, RAM-based main memory can communicate directly with file storage systems using Direct Memory Access (“DMA”) systems.

### CONCLUSION

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. An image recording system for storing digital image data that is related to an image, the image capturing system comprising:
a memory storage, having a plurality of memory modules; and
a memory controller configured to:
access digital image data in a raw image format that includes color information for a plurality of pixels of the image,
stripe the digital image data into a plurality of blocks of image data,
partition the plurality of blocks of image data into a plurality of blocks of pixel data, and
distribute the color information of pixels within the plurality of blocks of pixel data across different groups of memory modules from among multiple memory modules.

2. The image recording system of claim 1, wherein the color information comprises luminance or chrominance color components of YUV color model or red, green or blue color components of a red, green, blue (RGB) color model.

3. The image recording system of claim 1, wherein the pixels of the image are arranged in a first series of rows and a first series of columns to form an array of pixels, and
wherein the memory controller is configured to stripe the digital image data row-wise along the first series of rows into the plurality of blocks of image data.

4. The image recording system of claim 3, wherein the memory controller is configured to partition the plurality of blocks of image data into a plurality of second series of rows and a plurality of second series of columns to form a plurality of arrays of pixel data.

5. The image recording system of claim 1, wherein the memory controller is configured to distribute the color information of pixels in relation to their relative position within the plurality of blocks of pixel data.

6. The image recording system of claim 1, wherein the memory controller is configured to distribute the color information of pixels in relation to their color components.

7. The image recording system of claim 1, wherein the memory controller is configured to distribute the color information of pixels from among the plurality of pixels that are within the plurality of blocks of pixel data across the different groups of memory modules in a round-robin fashion.

8. A method for storing digital image data that is related to an image, the method comprising:
accessing, by an image recording system, digital image data in a raw image format that includes color information for a plurality of pixels of the image;
striping, by the image recording system, the digital image data into a plurality of blocks of image data;
partitioning, by the image recording system, the plurality of blocks of image data into a plurality of blocks of pixel data; and
distributing, by the image recording system, the color information of pixels within the plurality of blocks of pixel data across different groups of memory modules from among multiple memory modules.

9. The method of claim 8, wherein the color information comprises luminance or chrominance color components of YUV color model or red, green or blue color components of a red, green, blue (RGB) color model.

10. The method of claim 8, wherein the pixels of the image are arranged in a first series of rows and a first series of columns to form an array of pixels, and
wherein the striping comprises striping the digital image data row-wise along the first series of rows into the plurality of blocks of image data.

11. The method of claim 10, wherein the partitioning comprises partitioning the plurality of blocks of image data into a plurality of second series of rows and a plurality of second series of columns to form a plurality of arrays of pixel data.

12. The method of claim 8, wherein the distributing comprises distributing the color information of pixels in relation to their relative position within the plurality of blocks of pixel data.

13. The method of claim 8, wherein the distributing comprises distributing the color information of pixels in relation to their color components.

14. The method of claim 8, wherein the distributing comprises distributing the color information of pixels from among the plurality of pixels that are within the plurality of blocks of pixel data across the different groups of memory modules in a round-robin fashion.

15. An image capture system for storing digital image data that is related to an image, the image capturing system comprising:
a camera system configured to provide the digital image data in a raw format that includes color information for a plurality of pixels of the image; and
an image recording system configured to:
stripe the digital image data into a plurality of blocks of image data,
partition the plurality of blocks of image data into a plurality of blocks of pixel data, and
distribute the color information of pixels within the plurality of blocks of pixel data across different groups of memory modules from among multiple memory modules.

16. The image capture system of claim 15, wherein the pixels of the image are arranged in a first series of rows and a first series of columns to form an array of pixels, and
wherein the image recording system is configured to stripe the digital image data row-wise along the first series of rows into the plurality of blocks of image data.

17. The image capture system of claim 16, wherein the image recording system is configured to partition the plurality of blocks of image data into a plurality of second series of rows and a plurality of second series of columns to form a plurality of arrays of pixel data.

18. The image capture system of claim 15, wherein the image recording system is configured to distribute the color information of pixels in relation to their relative position within the plurality of blocks of pixel data.

19. The image capture system of claim 15, wherein the image recording system is configured to distribute the color information of pixels in relation to their color components.

20. The image capture system of claim 15, wherein the image recording system is configured to distribute the color information of pixels from among the plurality of pixels that are within the plurality of blocks of pixel data across the different groups of memory modules in a round-robin fashion.
